(19) United States
(12) Patent Application Publication
(10) Pub. No.: US 2007/0271077 A1
(43) Pub. Date: Nov. 22, 2007

(54) Optimizing Well System Models

(76) Inventors: Alexandre G.E. Kosmala, Croydon (GB); Kashif Rashid, Hounslow (GB)

Correspondence Address: SCHLUMBERGER TECHNOLOGY CORPORATION, 14910 AIRLINE ROAD, ROSHARON, TX, 77583, US

(21) Appl. No.: 10/531,828

(22) PCT Filed: Nov. 4, 2003
(86) PCT No.: PCT/GB03/04764

§ 371 Date: Sep. 11, 2006

(30) Foreign Application Priority Data
Nov. 15, 2002 (GB) 0226623.7
May 28, 2003 (GB) 0312142.3

(51) Int. Cl. G06G 7/48

(52) U.S. Cl. 703/5

(57) ABSTRACT

The invention is a controller functionally associated with a reservoir model, a well network model, and a processing plant model and is adapted to optimize any one, two, or all three of the models. The controller can optimize the models using multiple, the same, or different optimizer modules.

### BACKGROUND

The invention generally relates to a system and method for optimizing production from wellbores. In particular, the invention relates to a system and method for optimizing a reservoir model, a well network model in order, and/or a processing plant model to optimize the production from a wellbore.

A reservoir model is a mathematical representation of the subsurface, structures, fluids, and wells that can be used to carry out dynamic predictions of reservoir and fluid behavior. Reservoir models are typically used in the oil and gas industry to simulate reservoir and relevant fluid behavior given a set of input parameters. Often, simulations run based on reservoir models are optimized to provide an output that is maximized in relation to an objective function, such as maximizing profits or production.

A well network model is a nodal analysis model used to calculate pressure and flow rate (and sometimes temperature) for a network of wells, connecting pipework, and potential surface processing facilities. Well network models are typically used in the oil and gas industry to simulate pressure and flow of fluid within the network given a set of input parameters. As in the case of reservoir models, simulations run based on well network models are often optimized to provide an output that is maximized in relation to an objective function, such as maximizing profits or production.

It would be beneficial to provide a system and method which can optimize the reservoir model and/or the well network model using multiple, the same, or different objective functions. Among other advantages, by use of a system that can functionally couple a reservoir model and a well network model and that can optimize one or both of the models using selected objective functions, [1] the simulation is more representative of the real world, given the implicit uncertainties associated with each of the models (primarily the reservoir model); [2] the simulation can account for changing conditions with depletion of the reservoir and changes in the configuration at the well network level; [3] the user can specify more relevant real world engineering problems incorporating reservoir and well network models in a coupled context; [4] the results provided by optimizing a combined system are more realistic and meaningful given the inclusion of real constraints and model interaction; and [5] the key design parameters for each of the models can be user defined and optimized accordingly with a suitable optimizer or combination thereof to provide more relevant simulation results.

A processing plant model can also be coupled to the reservoir model and the well network model. A processing plant model is a mathematical representation of an upstream processing plant which simulates the work of the plant given various plant parameters, such as process capacity and physical constraints. Like the previous models, simulations run based on process plant models may be optimized in relation to an objective function. Linking the processing plant model to the reservoir model and/or the well network model provides the simulations the implicit real world uncertainties associated with a processing plant model, the ability to account for changes in the processing plant capacity, and a more realistic and overall view of the oil production process.

Thus there exists a continuing need for an arrangement and/or technique that addresses one or more of the problems that are stated above.

### SUMMARY

According to a first aspect, the present invention consists of a method optimizing an objective function related to a subterranean well system, comprising constructing a reservoir model and a well network model of the well system; functionally connecting a controller to the reservoir model and the well network model; running a simulation with at least one of the reservoir model and the well network model and with a set of input variables related to the at least one of the reservoir model and the well network model; and optimizing an objective function by varying the set of variables.

The invention further provides that the optimizing step can comprise optimizing an objective function that relates only to the reservoir model, the well network model, or to both the reservoir model and the well network model.

The invention further provides that the optimizing step can comprise optimizing a first objective function that relates to the reservoir model and optimizing a second objective function that relates to the well network model. The invention further provides that the optimizing of the first and second objective functions can occur simultaneously. The invention further provides that the optimizing of a first objective function step and optimizing a second objective function step can each comprise conducting the optimization with one of a discrete optimizer module, a continuous optimizer module, and a mixed-mode optimizer module. The invention further provides that the optimizing a first objective step and optimizing a second objective function step can be conducted using different optimizer modules.

The invention further provides that the objective function may be constrained with at least one secondary objective.

The invention further provides that the optimizing step can be conducted with a discrete optimizer module, a continuous optimizer module, or a mixed-mode optimizer module.

The invention further provides that the optimizing step can comprise maximizing the production of hydrocarbons from the well system. The invention further provides that the set of variables can comprise the positions of at least one valve located in the well system. The invention further provides that the well system can comprise a single wellbore, a plurality of wellbores, or at least one subsea wellbore.

The invention further provides that the optimizing step can comprise varying the set of variables using a directed search component and a random search component.

The invention further provides that the constructing step can comprise obtaining data from sensors located in the well system. The invention further provides that the obtaining step can comprise permanently deploying the sensors in the well system. The invention further provides that the obtaining step can comprise temporarily deploying the sensors in the well system.

The invention further provides that the constructing step can comprise constructing the reservoir model using at least one of reservoir data, well data, and production data from the well system.

The invention further provides that the constructing step can comprise constructing the well network model using at least one of pipeline physical data, fluid property data, and process element performance data from the well system.

The invention further provides that the method can further comprise: constructing a processing plant model related to the well system; functionally connecting the controller to the processing plant model; running a simulation with at least one of the reservoir model, the well network model, and the processing plant model and with a set of variables related to the at least one of the reservoir model, the well network model, and the processing plant model; and optimizing an objective function by varying the set of variables.

The invention further provides that the optimizing step can comprise optimizing an objective function that relates only to the processing plant model.

The invention further provides that the optimizing step can comprise optimizing an objective function that relates to at least two of the reservoir model, the well network model, and the processing plant model.

The invention further provides that the optimizing step can comprise optimizing an objective function that relates to each of the reservoir model, the well network model, and the processing plant model.

The invention further provides that the controller can be stored in a memory of a computer system. The invention further provides that the reservoir model and well network model can also be stored in the memory.

The invention further provides that a type of optimizer module can be selected to use for the optimizing step. The invention further provides that the selecting step can be performed by an operator or automatically by a computer system.

According to a first aspect, the present invention consists of a system for optimizing an objective function related to a subterranean well system, comprising: a storage medium including a reservoir model and a well network model of the well system; a controller functionally connected to the reservoir model and the well network model; a processor adapted to run a simulation with at least one of the reservoir model and the well network model and with a set of input variables related to the at least one of the reservoir model and the well network model; and the controller adapted to optimize an objective function by varying the set of variables.

The invention further provides that the objective function can relate only to the reservoir model, the well network model, or both the reservoir model and the well network model.

The invention further provides that the controller can optimize a first objective function that relates to the reservoir model and optimize a second objective function that relates to the well network model. The invention further provides that the controller can optimize each of the first and second objective functions with one of a discrete optimizer module, a continuous optimizer module, and a mixed-mode optimizer module. The invention further provides that the controller can optimize the first and second objective functions with a different optimizer module. The invention further provides that the controller can optimize the first and second objective functions simultaneously.

The invention further provides that the objective function can be constrained with at least one secondary objective.

The invention further provides that the controller can optimize the objective function with a discrete optimizer module, a continuous optimizer module, or a mixed-mode optimizer module.

The invention further provides that the objective function can be the maximization of the production of hydrocarbons from the well system.

The invention further provides that the set of variables can comprise the positions of at least one valve located in the well system.

The invention further provides that the well system can comprise a single wellbore, a plurality of wellbores or at least one subsea wellbore.

The invention further provides that the controller can be adapted to vary the set of variables using a directed search component and a random search component in order to optimize the objective function.

The invention further provides that the reservoir model can be constructed using data from sensors located in the well system. The invention further provides that the sensors can be permanently deployed in the well system. The invention further provides that the sensors can be temporarily deployed in the well system.

The invention further provides that the reservoir model can be constructed using at least one of reservoir data, well data, and production data from the well system.

The invention further provides that the well network model can be constructed using at least one of pipeline physical data, fluid property data, and process element performance data from the well system.

The invention further provides that the system can further comprise: the storage medium includes a processing plant model related to the well system; the controller is functionally connected to the processing plant model; the processor is adapted to run a simulation with at least one of the reservoir model, the well network model, and the processing plant model and with a set of variables related to the at least one of the reservoir model, the well network model, and the processing plant model; and the controller is adapted to optimize an objective function by varying the set of variables.

The invention further provides that the objective function can relate only to the processing planet model, to at least two of the reservoir model, the well network model, and the processing plant model, or to each of the reservoir model, the well network model, and the processing plant model.

The invention further provides that the storage medium can be a computer storage medium and the controller is also stored in the computer storage medium. The invention further provides that an optimizer module can be selected to optimize the objective function. The invention further provides that the optimizer module can be selected by an operator of the system or by the controller.

According to a third aspect, the invention provides a method of optimizing an objective function related to a subterranean well system, comprising: constructing a reservoir model and a well network model of the well system; functionally connecting a controller to the reservoir model and the well network model; selecting whether to optimize either or both of the reservoir model and the network model; choosing at least one objective function to optimize; running a simulation with a set of input variables related to at least one of the reservoir model and the well network model; and optimizing the at least one objective function by varying the set of variables.

Advantages and other features of the invention will become apparent from the following description, drawing and claims.

### BRIEF DESCRIPTION OF THE DRAWING

FIG. 1 is a general schematic showing the controller of this invention functionally associated with a reservoir model and a well network model.

FIG. 2 is a general schematic showing a reservoir model.

FIG. 3 is a general schematic showing a well network model.

FIG. 4 is a schematic of one embodiment of the multi-well system which the well network model may be used to model.

FIG. 5 is a schematic of another embodiment of the multi-well system which the well network model may be used to model.

FIG. 6 is a schematic of the connection present in one embodiment between a computer system and the multi-well systems.

FIG. 7 is a general schematic showing the optimizer modules located within the controller.

FIG. 8 is a schematic of one embodiment of a temporarily deployed sensor used to obtain data from a well.

FIG. 9 is a schematic of one embodiment of a permanently deployed sensor used to obtain data from a well.

FIG. 10 is a flow diagram of the function of the controller.

FIG. 11 is a flow chart of the function of the LSS.

FIG. 12 is a schematic of one embodiment of a single well system which the well network model may be used to model.

FIG. 13 is a general schematic showing the controller of this invention functionally associated with a reservoir model, a well network model, and a processing plant model.

FIG. 14 is a general schematic showing a processing plant model.

### DETAILED DESCRIPTION

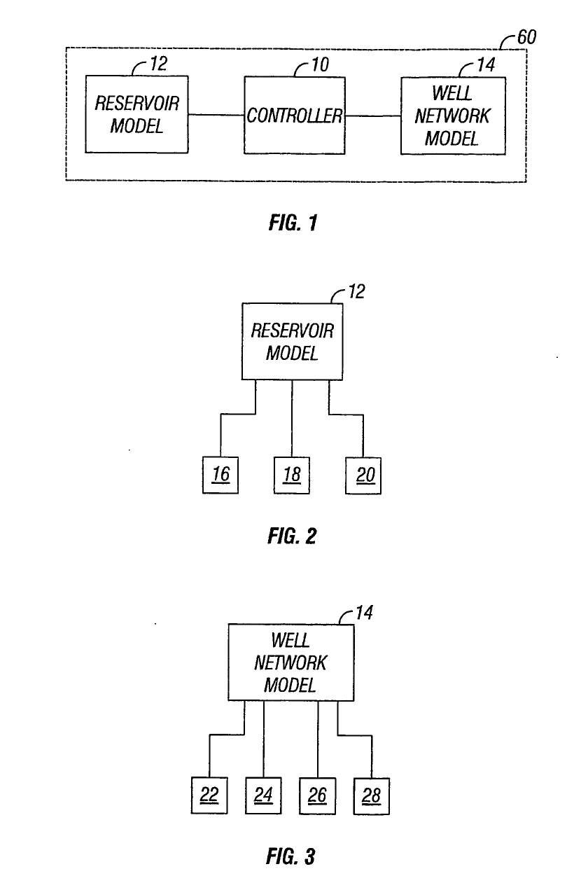

FIG. 1 shows a general schematic of the system 8 that makes up the present invention. System 8 comprises a controller 10 that may be functionally connected to a reservoir model 12 as well as to a well network model 14. The reservoir model 12 and the well network model 14 are associated with at least one wellbore. The controller 10 is adapted to optimize the reservoir model 12, the well network model 14, or both.

Generally, as previously described, a “reservoir model” is a mathematical representation of the subsurface, structures, fluids, and wells that can be used to carry out dynamic predictions of reservoir and fluid behavior. A reservoir model is typically constructed in a basic form early on in the life of a reservoir and can thereafter be refined and updated. The reservoir model 12, as shown in FIG. 2, is constructed by use of a variety of data, including reservoir data 16, well data 18, and production data 20. This data 16, 18, 20 can include, for instance, production rates and volumes, well logs, seismic data (3-D and 4-D), well locations and trajectories, well tests, well core sample analysis, pressure measurements, temperature measurements, velocity measurements, gas/oil ratio, fluid density, saturation level, viscosities, compressibilities, grain size and composition, sorting, depositional environment, permeability, reservoir geometry and properties, drilling data, formation tester data, and perforation locations. Moreover, much of this data 16, 18, 20 can be obtained through either permanently or temporarily deployed sensors or instruments. For instance, FIG. 8 shows a wireline logging tool 70 temporarily deployed within a well 72, which logging tool includes at least one sensor 71 used to obtain data relating to the well 72, fluids within the well 72, and/or the well 72 surroundings. Refinement and validation of the reservoir model 12 can be performed by incorporating additional data gathered from the reservoir into the model 12 throughout the life of the reservoir. For example, FIG. 9 shows permanent sensors 74 permanently deployed in the well 72. In one embodiment, the permanent sensors 74 can be point sensors (such as temperature or pressure sensors) attached to a production tubing 78 and communicating with the surface via a communication cable 76. In other embodiments, the permanent sensors can be distributed sensors, such as the distributed temperature sensor system offered by Sensor Highway Limited of the United Kingdom.

Also generally and as previously described, a “well network model” is a nodal analysis model used to calculate pressure and flow rate (and sometimes temperature) for a wellbore, possibly network of wells, and connecting pipework. The well network model 14, as shown in FIG. 3. is constructed by use of a variety of data, including pipeline physical data 20, fluid property data 22, process element performance data 24, and any other relevant exterior constraints 26. This data 22, 24, 26, 28 can include, for instance, the interior and exterior diameters of pipes, pipe lengths, pipe depths, viscosity and temperature of the relevant fluid, presence and performance of flow control elements such as pumps, separators, and valves, sand face performance, and other imposed constraints in a well such as the fact that a certain outlet must be at a given pressure based on third party demands.

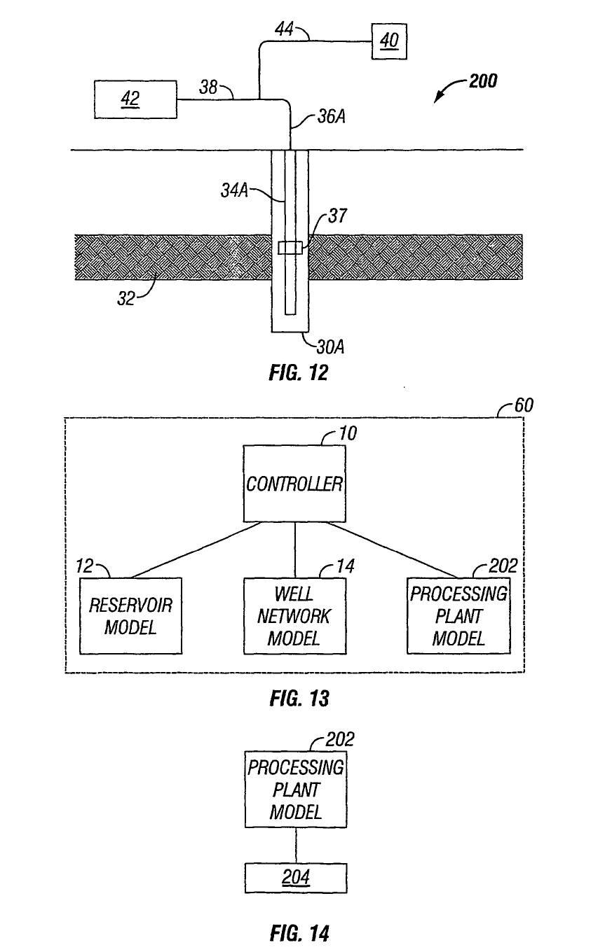

A well network model 14 may be made for a single well system 200 as shown in FIG. 12. In this Figure, a single well 30A is used to drain at least one formation 32 (and typically a plurality of formations). Well 30A has production tubing 34A which transports any produced hydrocarbons from the formation 32 to a transport pipe 36A. The production tubing 34A may have at least one equipment (and typically have a plurality of equipment) associated therewith which affects the performance of the fluid flow, such as a valve 37. The transport pipe 36A may turn into a main pipeline 38 which may transport the produced fluids to a surface processing facility 42. Moreover, additional well systems (either single or multiple well systems), such as generally shown at 40, may be joined to the main pipeline 38, such as by additional pipeline 44. The well network model 14 for well system 200 would enable the calculation of at least flow rate and pressure at any point in the system 200. The well network model 14 for well system 200 is created by using the relevant information, as described in the previous paragraph, for the production tubing 34A, valve 37, transport pipes 36A, main pipeline 38, additional well system 40, and additional pipeline 44.

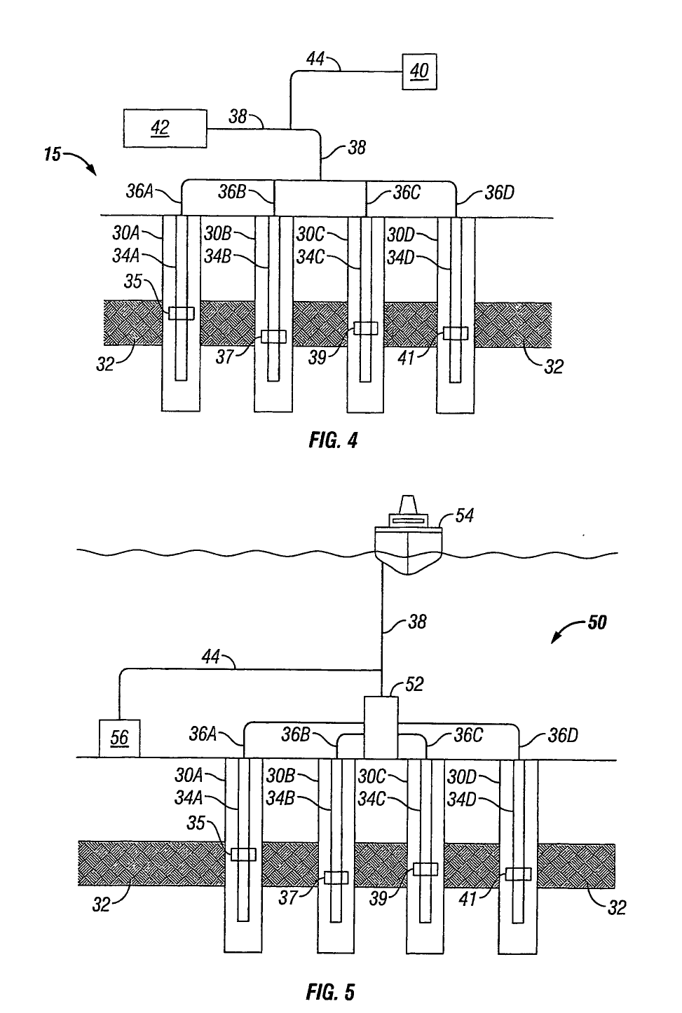

A well network model 14 may also be made for a multi-well system 15 as shown in FIG. 4. In this Figure, multiple wells 30A-D are used to drain a formation 32 (and typically a plurality of formations). Each well 30A-D may have production tubing 34A-D which transports any produced hydrocarbons from the formation 32 to a series of transport pipes 36A-D. Each of the production tubing 34A-D may have at least one equipment (and typically have a plurality of equipment) associated therewith which affects the performance of the fluid flow, such as pump 35, valve 37, separator 39, or choke 41. The transport pipes 36A-D may join together into a main pipeline 38 which may transport the produced fluids to a surface processing facility 42. Moreover, additional well systems (either single or multiple well systems), such as generally shown at 40, may be joined to the main pipeline 38, such as by additional pipeline 44. The well network model 14 for well system 15 would enable the calculation of at least flow rate and pressure at any point in the system 15. The well network model 14 for well system 15 is created by using the relevant information, as described in previously, for the production tubing 34A-D, pump 35, valve 37, separator 39, choke 41, transport pipes 36A-D, main pipeline 38, additional multiple system 40, and additional pipeline 44.

A well network model 14 may also be made for a multi-well system 50 as shown in FIG. 5. In this Figure, multiple wells 30A-D are used to drain a formation 32 (and typically a plurality of formations), however each of the wells 30A-D is a subsea well. Each well 30A-D may have production tubing 34A-D which transports any produced hydrocarbons from the formation 32 to a series of subsea transport pipes 36A-D. Each of the production tubing 34A-D may have at least one equipment (and typically have a plurality of equipment) associated therewith which affects the performance of the fluid flow, such as pump 35, valve 37, separator 39, or choke 41. The transport pipes 36A-D may join together at a manifold 52 into a main pipeline 38 which may transport the produced fluids to a ship 54 or other facility. Moreover, additional subsea well systems (either single or multiple well systems), such as shown at 56, may be joined to the main pipeline 38, such as by additional subsea pipeline 44. The utility and creation of the well network model 14 for this subsea multiwell system 50 is as described in the previous paragraph.

In one embodiment of the invention as shown in FIG. 13, controller 10 may also be functionally connected to a processing plant model 202. “Processing plant model” is a mathematical representation of a processing plant, such as an upstream processing facility 42, as shown in FIGS. 4 and 12. Processing plant model 202, as shown in FIG. 14, is constructed by use of a variety of data, including the input, process, physical constraints, process capacity, and output of the processing plant generally shown as 204.

As known in the art, the reservoir model 12 and the well network model 14 are used to simulate the effect the reservoir and well system would have based on a given set of input parameters chosen by an operator. The simulations provide a more complete understanding of reservoir behavior and help the operator make decisions regarding the reservoir and well system based on desired outputs. The processing plant model 202 may be used to simulate the upstream effects and constraints on the overall production. Together, the reservoir model 12, the well network model 14, and the processing plant model 202 give operators an overall view of the production flow.

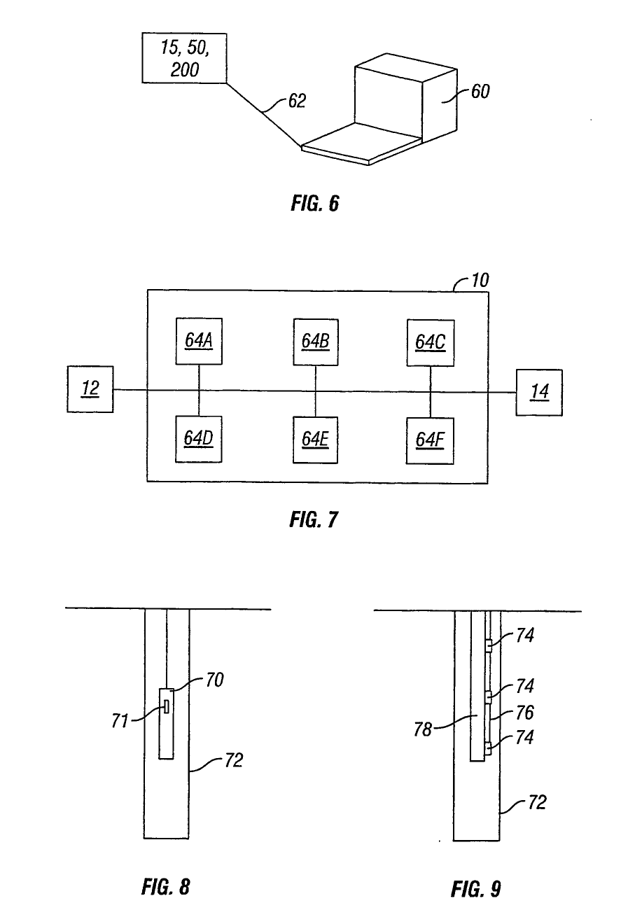

The reservoir model 12, the well network model 14, and the processing plant model 202 may be stored within a computer system 60, shown as dotted lines in FIGS. 1 and 13 and regularly in FIG. 6. The models 12, 14, and 202 may be stored in the computer system's memory, and the computer system's processor(s) may function to run the model simulations. In one embodiment, the models 12, 14, and 202 comprise at least one software package that is loaded for execution on the computer system 60. In other embodiments, the models 12, 14, and 202 can be implemented as a special-purpose hardware information module.

The computer system 60 may be located remotely from the well systems 15, 50, or 200. In some embodiments, the computer system 60 is remotely connected to sensors and other equipment in the well systems 15, 50, or 200 and also to sensors and other equipment in the physical pipes and equipment that comprise the well network model 14 and the processing plant model 202. This remote connection enables the intermittent or continuous (as the case may be) transmission of data from the relevant sensors and equipment to the computer system 60. Reception of such data by the computer system 60 allows the models 12, 14, and 202 to be updated, either intermittently or continuously. Such remote transmission of data can occur via a transmission route 62 which can comprise the internet, satellite signals, electronic or fiber optic cable, telephone lines, or other local network.

The controller 10 may also be located in the computer system 60, such as being stored in the computer system's 60 memory. The controller 10 is functionally connected to the reservoir model 12, the well network model 14, and/or the processing plant model 202. In one embodiment, the controller 10 is included in the software package that is loaded for execution on the computer system 60. In other embodiments, the controller 10 is part of the special-purpose hardware information module previously described. The controller 10 manages the information between models 12, 14, and 202 thereby enabling simulations to be run incorporating all of the models.

In the embodiment not including the processing plant model 202, the controller 10 is adapted to optimize the reservoir model 12, the well network model 14, or both. In the embodiment including the processing plant model 202, the controller 10 is adapted to optimize the reservoir model 12, the well network model 14, the processing plant model 202, two of them, or all three. In other words, each of the reservoir model 12, the well network model 14, and the processing plant model 202 may be isolated and optimized, or two, or all of the models 12, 14, and 202 may be optimized together, depending on the desires and problem solving strategy of the operator.

The controller 10 may optimize each of the models 12, 14, or 202 with respect to different stipulated objective functions. The reservoir model 12 can be optimized alone, for instance, to manage well placements, zonal isolation and for pressure maintenance in order to maximize recovery and therefore to maximize monetary return. Each of the well network model 14 and the processing plant model 202 can be optimized alone, for instance, for capacity and pressure to maximize recovery, reduce costs, and maximize monetary return.

The reservoir model 12 can also be optimized together with the well network model 14 for oil recovery and profits taking into account the changing reservoir conditions with time (i.e. reservoir depletion). The processing plant model 202 can also be coupled into the optimization scheme in order to take into account the upstream effects and constraints of the production process.

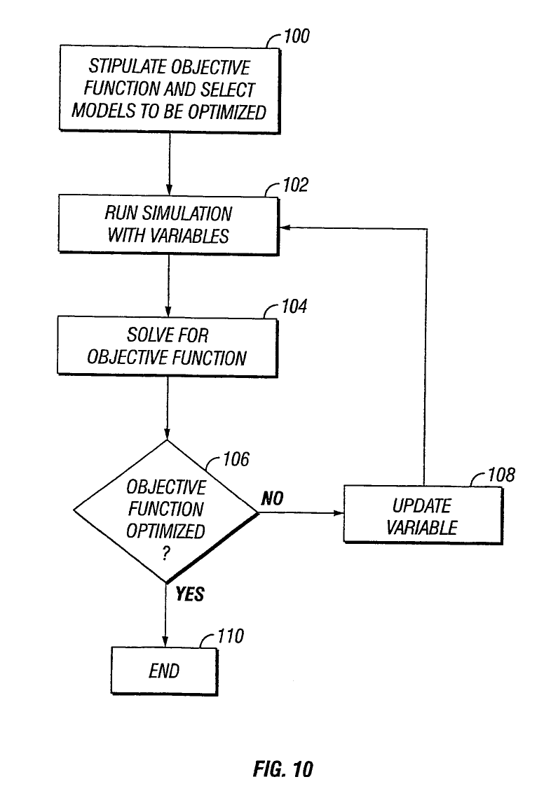

In general, and as shown in FIG. 10, at step 100 an operator first stipulates the objective function(s) to be optimized and selects the models that should be optimized in relation to the objective function(s). A simulation is then run at step 102 based on an initial set of input variables and using the selected models. At step 104, the objective function is solved based on the model simulations and the set of input variables. At step 106, the controller 10 tests to determine whether the objective function has been optimized by use of the current set of input variables. If optimization has not occurred, then at step 108 the controller 10 updates the set of input variables with the aim of optimizing the solution for the objective function and returns the flow to step 102. The process continues until the objective function is optimized (as defined by the operator), and the final set of input variables is identified as the setting which provides the optimum solution based on the stipulated objective function. If optimized, the process ends at step 110.

A schematic of the controller 10 is shown in FIG. 7. The controller 10 comprises a plurality of optimizer modules, shown in the Figure as 64A-F. In one embodiment, each optimizer module 64 is selected to solve the particular resulting optimization problem based on the objective function stipulated, the parameters, and the constraints specified. Based on his/her desires, the operator of the computer system 60 may activate or deactivate any of the optimizer modules 64 or may even configure a new optimizer module 64. Moreover, the operator of the computer system 60 may indicate whether a particular activated optimizer module 64 is to optimize the reservoir model 12, the well network model 14, the processing plant model 202, two of them, or all three. An operator may also activate different optimizer modules 64 for each of the reservoir model 12, the well network model 14, and the processing plant model 202. Or, an operator may also decide to optimize only one or two of the models, 12, 14, and 202.

In order to provide the ability to solve different types of problems, the controller 10 may also include optimizer modules 64 that are discrete optimizer modules, continuous optimizer modules, or mixed mode optimizer modules. Discrete optimizer modules optimize a parameter in relation to fixed positions/solutions within a range, such as when a downhole valve has a plurality of discrete positions between open and close (including just open and close). Continuous optimizer modules optimize a parameter in relation to an infinite number of positions/solutions within a range, such as when a downhole valve has an infinite number of positions between open and close. Mixed mode optimizer modules optimize a parameter in relation to fixed positions/solutions for some elements (such as discrete position downhole valve) and to an infinite number of positions/solutions for other elements (such as downhole valves with an infinite number of settings). Mixed mode optimizer modules are valuable in more complex field managements when both discrete and infinite position/solution elements must be optimized.

Once the objective function is defined by the operator, the operator, in one embodiment, can select which optimizer module 64 is best suited to optimize the relevant objective function. Selection of an optimizer module 64 depends on many factors, including the actual objective function, the constraints applied, linearity, non-linearity, and the availability of sensitivity information. As previously discussed, an operator may partition the work between optimizer modules 64 if necessary or may select one optimizer module 64 for the entire problem, if possible.

There are also several methods used to address multi-objective problems, such as when at least one model 12, 14, 202 is to be optimized based on more than one objective or when different models 12, 14, 202 are optimized based on different objectives. In one method, each of the objectives is incorporated or summed into the main objective function, with each of the multiple objectives being given a weight in relation to the other objectives. In another method, objectives other than the first main objective are incorporated into constraints built into the main objective function. And in yet another method, each of the objectives is optimized independently and are then coupled together to provide a number of equally feasible solutions to the operator. An operator decides which method to use based on a variety of factors, including his/her problem solving knowledge and experience. In another embodiment, the solution method is automatically selected by the controller 10 based on the objective function defined by the operator and on additional information provided by the user.

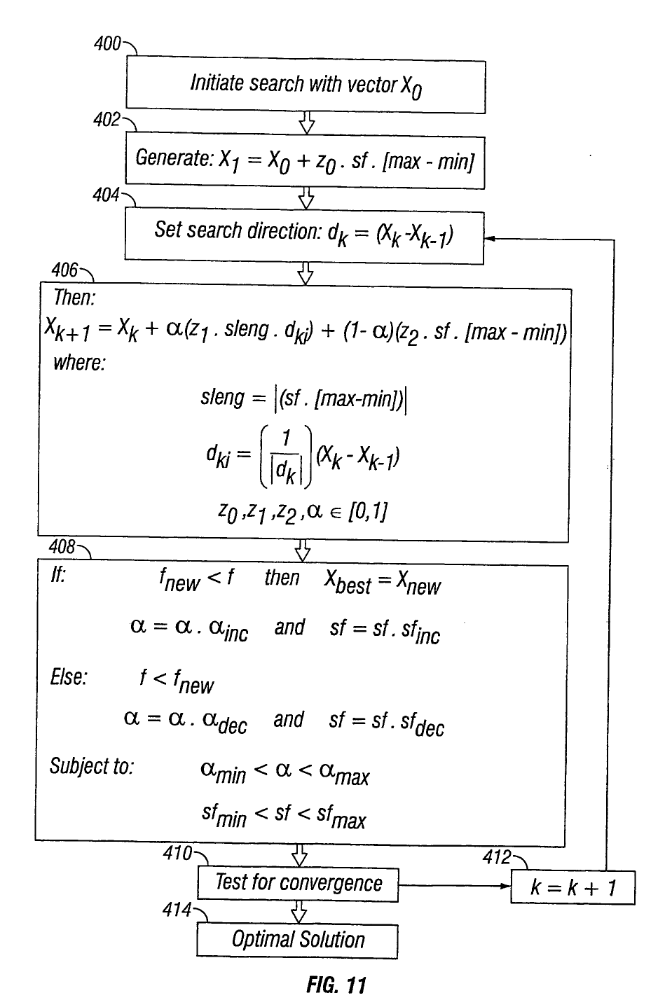

One embodiment of an optimizer module 64 is the local stochastic search algorithm (“LSS”) shown in FIG. 11. Generally, the LSS algorithm is an ad-hoc optimization algorithm designed to operate under discrete, continuous and mixed-mode domains. The algorithm is derivative free, robust, can handle constraints via scaled penalty terms and is suitable for combinatorial problems, of the type identified for its motivation.

At initial step 400, the controller 10 initiates the search with a starting vector X₀. At step 402, X₁ is calculated as follows:
X₁=X₀+z₀ sf[max−min], (1)
wherein z₀ is a random stochastic variable between 0 and 1, sf is a step factor indicating the max possible step for a given variable, and [max−min] defines the bounds of a given variable. X₁ thus represents X₀ plus a random augmentation term provided by the optimizer at the first iteration. The search direction is then set at step 404 as follows:
dₖ=(Xₖ−Xₖ₋₁), (2)
wherein Xₖ is the current vector and Xₖ₋₁ is the previous vector. At step 406, the LSS establishes the new search vector as follows:

$$\begin{matrix}{X}_{k + 1} = {X}_{k} + α ( {z}_{1} \cdot sleng \cdot {d}_{ki} ) + ( 1 - α ) ( {z}_{2} \cdot sf \cdot [ max - min ] ) , with & ( 3 ) \\ sleng = \vert ( sf \cdot [ max - min ] ) \vert , & ( 4 ) \\ {d}_{ki} = ( \frac{1}{\vert {d}_{k} \vert} ) ( {X}_{k} - {X}_{k - 1} ) , and & ( 5 ) \\ {z}_{0} , {z}_{1} , {z}_{2} , α ∈ [ 0 , 1 ] , & ( 6 )\end{matrix}$$

wherein α is the weight of the directed search component and is between 0 and 1, (1−α) is the weight of the random search component, z_{0,1,2,3} are random stochastic variables between 0 and 1 which assign the actual step size taken as a fraction of the maximum step possible, and dₖᵢ is the unit vector of the search direction vector dₖ. Thus, Xₖ₊₁ is a search vector influenced by a directed search component, α(z₁ sleng dₖᵢ), and a random search component (1−α)(z₂ sf [max−min]). The objective function (ƒ) is then solved for and the relevant directed and random search weights α, (1−α) are changed in step 408 as follows:
If: ƒ_{new}<ƒthen X_{best}=X_{new} (7)
α=α·α_{inc} and sf=sf·sf_{inc} (8)
Else: ƒ<ƒ_{new} (9)
α=α·α_{dec} and sf=sf·sf_{dec} (10)
Subject to: αₘᵢₙ<α<αₘₐₓ (11)
sfₘᵢₙ<sf<sfₘₐₓ (12)
If the newly solved function (ƒ_{new}) is less than the previous function (ƒ), then the optimizer assumes that the new vector X_{new} provides a superior solution than the previous vector and saves the current vector X_{new} as the best solution vector found thus far, X_{best}. The optimizer then also increases the weight of α by a user defined scalar of α_{inc} (such as 20%) and increases the step factor sf by a user defined scalar of sf_{inc} (such as 20%), since the optimizer assumes that the search is being conducted in a satisfactory direction. If the newly solved function (ƒ_{new}) is greater than the previous function (ƒ). then the optimizer assumes that the new vector X_{new} provides an inferior solution than the previous vector and retains the previous vector as the best solution vector found thus far, X_{best}. The optimizer then also decreases the weight of α by a user defined scalar of α_{dec} (such as 20%) and decreases the step factor sf by a user defined scalar of sf_{dec} (such as 20%), since the optimizer assumes that the search is being conducted in a poor direction. It is noted that as shown, the optimizer assumes that the function (ƒ) is being minimized. However, it will be recognized that a maximization problem can also be solved by introducing a multiplier of (−1).

Next, in step 410, the optimizer tests for convergence to determine if the optimum solution for the objective function has been found. As with most evolutionary type algorithms, the LSS requires termination conditions for ceasing its search. This may be provided by a number of convergence criteria, such as the maximum number of search steps, maximum number of no function improvement steps, maximum number of attempts to generate a feasible vector, and the count of duplicate search vectors generated. The last two tests indicate that all feasible and possible search steps from the current have been explored. If the test at step 410 results in convergence, then the optimizer goes to step 414 and presents the best solution (X_{best}) to the user as an optimal solution. If the test does not result in convergence, then the optimizer proceeds to step 412 wherein the iteration number is increased by 1, and the process returns to step 404. From steps 404 to 410, the optimizer repeats its search until the test in step 410 results in convergence.

The LSS optimizer can be operated in continuous mode, discrete mode, or mixed mode. The scheme shown in FIG. 11 shows the LSS operation in continuous mode. For the LSS to operate in discrete mode, a constraint is added in step 406 that ensures Xₖ₊₁ must coincide within certain predefined discrete positions. For example, in relation to FIG. 11, the following constraint may be added to ensure discrete mode performance in step 406:
X_{new}=Xₖ₊₁ subject to max {Xₖ₊₁−Xₖ}≦maxdstep (13)
For the LSS to operate in mixed mode, the search vector is effectively partitioned into two sub-vectors, one vector describing the continuous variables and the second vector describing the discrete variables.

The LSS algorithm is an evolutionary algorithm. Typical of algorithms in this class it employs a stochastic update mechanism in the pursuit of function improvement. As illustrated, the LSS undertakes a local search moving from a current search point to a more feasible one. It can therefore be considered a variant of the (1+1) evolutionary strategy. That is, one parent yielding one offspring at each step, with the better candidate surviving to continue the search process. In another embodiment, the algorithm can be made to undertake a global search by setting the maximum possible step size to be high initially and reducing this with each step, akin to the temperature schedule in simulated annealing.

The algorithm comprises a single search vector, which is updated at each step with the addition of a weighted term for directed search and one for random search. As the method is derivative free, the direction of search, that perceived to be the direction of descent as illustrated, is provided by the difference between two consecutive search vectors. The weight of directed search increases with each reduction in function value and conversely reduces to random search when no function improvement is found.

The LSS handles constraints with the addition of penalty terms for each constraint in violation, given by the following augmented function:

$$Q ( X ) = F ( X ) + γ {\sum }_{i = 1}^{{c}_{v}} i \cdot {P}_{i} ( X , C ) \qquad ( 14 )$$

where, c_{ν} (number of constraints in violation)<c (total number of constraints), γ is a constant penalty factor and Pᵢ(X, C), the penalty function for the i-th constraint in violation, is a function of X and the constraint matrix C. The multiplier term provided by the i-th violated constraint ensures that the worst feasible solution is superior to the best infeasible solution. This allows the algorithm to start from both feasible and infeasible starting search vectors.

Bound constraints are handled separately from those specifically assigned, though a similar policy of adding a penalty term to the overall cost function for each variable exceeding its bounds is adopted.

The algorithm is also made to store all vectors searched, such as in computer system 60 memory, so that duplication of effort is avoided. This is important when solutions are sought from a numerical solver. Further, this information can be employed in the development and application of a generalized response surface to improve the efficiency of the search mechanism. A new search vector is generated repeatedly until one, which is feasible, non-duplicate and within bounds is found.

The ability to hill climb, that is, escape from a local minimum, is an important feature of most evolutionary algorithms. As illustrated, the LSS performs a local search, under the assumption that the optimal valve position vector will be in the neighbourhood of the current operating vector. Nonetheless, as previously disclosed, this global search ability can be provided in the illustrated algorithm by increasing the search step size at the outset or once a local minimum has been found.

In one embodiment, the controller 10 and an optimizer module 64 (such as the LSS) can be used to manage and control the positions of the downhole valves in an intelligent completion in order to maximize the oil produced. The number, type, and settings of the valves employed (discrete or continuous) are defined in the well network model 14 and the settings are included as the input variables to the objective function (e.g. maximizing the oil produced for a given valve definition). The valve settings are then varied by the optimizer module 64 in order to optimize the objective function. The output of this optimized simulation would then be the valve settings for the given number and type of valves resulting in maximum oil production. An operator can then set the actual valves in the well system to the settings provided by the optimized solution.

Besides maximizing the oil produced or the profits made, other objective functions can include minimizing the water produced, or controlling the gas-oil ratio. As previously described, depending on the problem-solving scheme chosen, primary and secondary objectives can be managed through the use of constraints. For instance, the objective function can be maximizing oil recovery while the constraints can be minimizing water cut and/or ensuring the capacity constraints are met at well and separator level.

Instead of the valve settings being the input variable for the objective function, other input variables can be used, such as flowline management, control of artificial lift parameters, pump speed, separator pressure, and capacity size.

The versatility of the approach described is characterized by the ease with which an objective function can be designed by the user and by the use of specific optimizers for the treatment of a given optimization problem (that is, the application of specific discrete, continuous, or mixed mode optimizers according to need). Moreover, the approach enables the linking of two or more models, as the operator desires, as well as the selection of different optimizers for each model or the decision not to optimize certain models.

In one embodiment, a rationalization module (not shown) is also incorporated with or to the controller 10. The rationalization module correlates all of the constraints included in the optimization procedure in relation to the reservoir model 12, well network model 14, and processing plant model 202. This has the benefit of ensuring consistency and preventing conflict during the simulation and during the optimization process. In addition, in order for the optimizer module to effectively optimize, the optimizer module needs to be aware of the constraints of each of the models. Therefore, the controller transfers the constraints from each of the models (12, 14, 202) to the rationalization module, which determines whether there is a conflict. If there is no conflict, then the optimizer module will optimize the operation. If there is a conflict, then the rationalization module will identify the conflicting constraints at the outset. The module may then alert the user and/or automatically resolve the conflict, such as by modifying the conflicting constraints (within certain guidelines, such as a hierarchy) to remove the conflict. Then, the optimizer module will optimize the operation.

As an example, if one of the reservoir model 12 constraints is a maximum flowing bottomhole pressure that is less than the suction pressure of a separator (part of the well network model 14), then, in physical terms, there would be no flow in the wellbore and the simulation run would crash, give spurious results, or return as unresolved. In this case, the controller obtains the constraints for the flowing bottomhole pressure and the separation suction pressure and transfers them to the rationalization module, which would identify the conflict to the user or automatically resolve as above.

Instructions of the various software routines or modules discussed herein (such as the reservoir model 12, the well network model 14, the processing plant model 202, the controller 10, or the optimizer modules 64) are stored on one or more storage devices in a system and loaded for execution on a control unit or processor. The control unit or processor includes microprocessors, microcontrollers, processor modules or subsystems (including one or more microprocessors or microcontrollers), or other control or computing devices. As used here, a “controller” or “module” refers to hardware, software, or a combination thereof. A “controller” or “module” can refer to a single component or to plural components (whether software, hardware, or a combination thereof).

Data and instructions (of the various software modules and layers) are stored in a storage device, which can be implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software modules or layers are loaded or transported to the system in one of many different ways. For example, code segments including instructions stored on floppy disks, CD or DVD media, a hard disk, or transported through a network interface card, modem, or other interface device are loaded into the system and executed as corresponding software modules or layers. In the loading or transport process, data signals that are embodied in carrier waves (transmitted over telephone lines, network lines, wireless links, cables, and the like) communicate the code segments, including instructions, to the system. Such carrier waves are in the form of electrical, optical, acoustical, electromagnetic, or other types of signals.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method of optimizing an objective function related to a subterranean well system, comprising:
constructing a reservoir model and a well network model of the well system;
functionally connecting a controller to the reservoir model and the well network model;
running a simulation with at least one of the reservoir model and the well network model and with a set of input variables related to the at least one of the reservoir model and the well network model; and
optimizing an objective function by varying the set of variables.

2. The method of claim 1, wherein the optimizing step comprises optimizing an objective function that relates only to the reservoir model.

3. The method of claim 1, wherein the optimizing step comprises optimizing an objective function that relates only to the well network model.

4. The method of claim 1, wherein the optimizing step comprises optimizing an objective function that relates to both the reservoir model and the well network model.

5. The method of claim 1, wherein the optimizing step comprises optimizing a first objective function that relates to the reservoir model and optimizing a second objective function that relates to the well network model.

6. The method of claim 5, wherein the optimizing of the first and second objective functions occurs simultaneously.

7. The method of claim 6, wherein the optimizing a first objective function step and optimizing a second objective function step each comprises conducting the optimization with one of a discrete optimizer module, a continuous optimizer module, and a mixed-mode optimizer module.

8. The method of claim 7, wherein the optimizing a first objective step and optimizing a second objective function step are conducted using different optimizer modules.

9. The method of claim 1, further comprising constraining the objective function with at least one secondary objective.

10. The method of claim 1, further comprising conducting the optimizing step with a discrete optimizer module.

11. The method of claim 1, further comprising conducting the optimizing step with a continuous optimizer module.

12. The method of claim 1, further comprising conducting the optimizing step with a mixed-mode optimizer module.

13. The method of claim 1, wherein the optimizing step comprises maximizing the production of hydrocarbons from the well system.

14. The method of claim 13, wherein the set of variables comprises the positions of at least one valve located in the well system.

15. The method of claim 1, wherein the well system comprises a single wellbore.

16. The method of claim 1, wherein the well system comprises a plurality of wellbores.

17. The method of claim 1, wherein the well system comprises at least one subsea wellbore.

18. The method of claim 1, wherein the optimizing step comprises varying the set of variables using a directed search component and a random search component.

19. The method of claim 1, wherein the constructing step comprises obtaining data from sensors located in the well system.

20. The method of claim 19, wherein the obtaining step comprises permanently deploying the sensors in the well system.

21. The method of claim 19, wherein the obtaining step comprises temporarily deploying the sensors in the well system.

22. The method of claim 1, wherein the constructing step comprises constructing the reservoir model using at least one of reservoir data, well data, and production data from the well system.

23. The method of claim 1, wherein the constructing step comprises constructing the well network model using at least one of pipeline physical data, fluid property data, and process element performance data from the well system.

24. The method of claim 1, further comprising:
constructing a processing plant model related to the well system;
functionally connecting the controller to the processing plant model;
running a simulation with at least one of the reservoir model, the well network model, and the processing plant model and with a set of variables related to the at least one of the reservoir model, the well network model, and the processing plant model; and
optimizing an objective function by varying the set of variables.

25. The method of claim 24, wherein the optimizing step comprises optimizing an objective function that relates only to the processing plant model.

26. The method of claim 24, wherein the optimizing step comprises optimizing an objective function that relates to at least two of the reservoir model, the well network model, and the processing plant model.

27. The method of claim 24, wherein the optimizing step comprises optimizing an objective function that relates to each of the reservoir model, the well network model, and the processing plant model.

28. The method of claim 1, further comprising storing the controller in a memory of a computer system.

29. The method of claim 28, further comprising storing the reservoir model and well network model in the memory.

30. The method of claim 1, further comprising selecting a type of optimizer module to use for the optimizing step.

31. The method of claim 30, wherein the selecting step is performed by an operator.

32. The method of claim 30, wherein the selecting step is performed automatically by a computer system.

33. A system for optimizing an objective function related to a subterranean well system, comprising:
a storage medium including a reservoir model and a well network model of the well system;
a controller functionally connected to the reservoir model and the well network model;
a processor adapted to run a simulation with at least one of the reservoir model and the well network model and with a set of input variables related to the at least one of the reservoir model and the well network model; and
the controller adapted to optimize an objective function by varying the set of variables.

34. The system of claim 33, wherein the objective function relates only to the reservoir model.

35. The system of claim 33, wherein the objective function relates only to the well network model.

36. The system of claim 33, wherein the objective function relates to both the reservoir model and the well network model.

37. The system of claim 33, wherein the controller optimizes a first objective function that relates to the reservoir model and optimizes a second objective function that relates to the well network model.

38. The system of claim 37, wherein the controller optimizes each of the first and second objective functions with one of a discrete optimizer module, a continuous optimizer module, and a mixed-mode optimizer module.

39. The system of claim 38, wherein the controller optimizes the first and second objective functions with a different optimizer module.

40. The system of claim 37, wherein the controller optimizes the first and second objective functions simultaneously.

41. The system of claim 33, further comprising constraining the objective function with at least one secondary objective.

42. The system of claim 33, wherein the controller optimizes the objective function with a discrete optimizer module.

43. The system of claim 33, wherein the controller optimizes the objective function with a continuous optimizer module.

44. The system of claim 33, wherein the controller optimizes the objective function with a mixed-mode optimizer module.

45. The system of claim 33, wherein the objective function is the maximization of the production of hydrocarbons from the well system.

46. The system of claim 45, wherein the set of variables comprises the positions of at least one valve located in the well system.

47. The system of claim 33, wherein the well system comprises a single wellbore.

48. The system of claim 33, wherein the well system comprises a plurality of wellbores.

49. The system of claim 33, wherein the well system comprises at least one subsea wellbore.

50. The system of claim 33, wherein the controller is adapted to vary the set of variables using a directed search component and a random search component in order to optimize the objective function.

51. The system of claim 33, wherein the reservoir model is constructed using data from sensors located in the well system.

52. The system of claim 51, wherein the sensors are permanently deployed in the well system.

53. The system of claim 51, wherein the sensors are temporarily deployed in the well system.

54. The system of claim 33, wherein the reservoir model is constructed using at least one of reservoir data, well data, and production data from the well system.

55. The system of claim 33, wherein the well network model is constructed using at least one of pipeline physical data, fluid property data, and process element performance data from the well system.

56. The system of claim 33, further comprising:
the storage medium includes a processing plant model related to the well system;
the controller is functionally connected to the processing plant model;
the processor is adapted to run a simulation with at least one of the reservoir model, the well network model, and the processing plant model and with a set of variables related to the at least one of the reservoir model, the well network model, and the processing plant model; and
the controller is adapted to optimize an objective function by varying the set of variables.

57. The system of claim 56, wherein the objective function relates only to the processing plant model.

58. The system of claim 56, wherein the objective function relates to at least two of the reservoir model, the well network model, and the processing plant model.

59. The system of claim 56, wherein the objective function relates to each of the reservoir model, the well network model, and the processing plant model.

60. The system of claim 33, wherein the storage medium is a computer storage medium and the controller is also stored in the computer storage medium.

61. The system of claim 33, wherein an optimizer module is selected to optimize the objective function.

62. The system of claim 61, wherein the optimizer module is selected by an operator of the system.

63. The method of claim 61, wherein the optimizer module is selected by the controller.

64. A method of optimizing an objective function related to a subterranean well system, comprising:
constructing a reservoir model and a well network model of the well system;
functionally connecting a controller to the reservoir model and the well network model;
selecting whether to optimize either or both of the reservoir model and the network model;
choosing at least one objective function to optimize;
running a simulation with a set of input variables related to at least one of the reservoir model and the well network model; and
optimizing the at least one objective function by varying the set of variables.
